(19) United States
(12) Patent Application Publication
(10) Pub. No.: US 2003/0142096 A1
(43) Pub. Date: Jul. 31, 2003

(54) Circuit for controlling display of modulated image in an image display device, and image display method and device

(76) Inventor: Koji Yano, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/353,978

(22) Filed: Jan. 30, 2003

(30) Foreign Application Priority Data
Jan. 31, 2002 (JP) 23437/2002

(51) Int. Cl. G06T 17/00

(52) U.S. Cl. 345/440

(57) ABSTRACT

A modulated image display control circuit is provided for more rapidly displaying a modulated image such as a persistence image. An image display device comprises a persistence display control circuit for controlling a display of an image on a raster scan type display. The persistence display control circuit adds persistence pixel data to input pixel data within an input image frame supplied to the display to generate display pixel data within a display image frame which is supplied to the display. For generating the display pixel data, the persistence display control circuit comprises a persistence pixel data formation unit and a persistence pixel data adder unit. The formation unit forms persistence pixel data to be added to the input pixel data during a frame immediately after an input image frame which contains the input pixel data. The adder unit adds persistence pixel data at a pixel position corresponding to the input pixel data to the input pixel data.

### BACKGROUND OF THE INVENTION

The present invention relates to display of an image such as a waveform, and more particularly, to a circuit for controlling display of a modulated image such as a persistence or afterglow added image, and to an associated image display method and device.

Conventionally, a variety of techniques are known in the art of a raster scan type digital oscilloscope for providing a persistence or afterglow characteristic as provided in an analog oscilloscope. For example, Laid-open Japanese Patent Application No. 7-280842 entitled “Digital Image Display Device”, opened to the public on Oct. 27, 1995, discloses a raster scan type digitizing oscilloscope which comprises a display memory and a decrementer state machine for providing “gray scale information (or a variable persistence characteristic)”, visible in an analog oscilloscope. A decrementer disposed in the digitizing oscilloscope reads pixel data from the display memory on a pixel-by-pixel basis, decrements the read pixel data, and then rewrites the decremented pixel data to an original memory location. However, in using this processing a data transfer rate from a frame memory to a display is limited to one half (or less) of a memory access rate of the display memory, i.e., a maximum of one frame memory. Also, since the processing must be repeated for each pixel, the frame memory must also be switched between a read and a write state in pixel units, which requires use of a complicated switching control. Further, since image data is not taken into the frame memory at the same time as that for decrementing for a persistence display, a resulting image is intermittently displayed.

In Laid-open Japanese Patent Application No. 4-313066 entitled “Display Device”, opened to the public on Nov. 5, 1992, a display such as a CRT display increments or decrements a display content as appropriate, at an attenuation rate in accordance with the content to be displayed, to thereby provide in a raster scan type digital oscilloscope an afterglow or persistence characteristic mode provided in an analog oscilloscope. This display device includes a buffer memory for modulating image data, and reads the image data from the buffer memory, modulates the read image data, and rewrites the modulated image data into the buffer memory. However, a problem exists in this technique, as is the case with the aforementioned laid-open Japanese Patent Application No. 7-280842, in that a data transfer rate from the buffer memory or a frame memory to the display is limited to one half or less of the memory access rate of the frame memory.

Further, Laid-open Japanese Patent Application No. 6-317609 entitled “Display Circuit Apparatus”, and opened to the public on Nov. 15, 1994 discloses a display circuit apparatus which comprises a display frame memory, provided between a capture frame memory and a display, for realizing a variable persistence characteristic as provided in an analog oscilloscope. The display frame memory is used for writing a persistence data added display image frame, and for reading the frame to the display (for example, a Braun tube) and to a subtractor for forming persistence data. The provision of the display frame memory enables input image data to be captured even during persistence processing, thereby providing for a continuous waveform display. However, since two frame memories are connected in cascade between the image data input and the display, a signal to the display must pass through the frame memory twice, which results in three intervening frame periods: a write period in which the signal is written into the display frame memory, a read period in which the signal is read from the display frame memory (which also serves as a write period in which the signal is written into the display frame memory), and a read period in which the signal is read from the display frame memory. The existence of these three intervening three frame periods causes a significant delay from a time when image data is input to a time when a waveform is displayed, which makes it impossible to display an input image in real time.

### SUMMARY OF THE INVENTION

To overcome the problems of the prior arts as described above, it is an object of the present invention to provide a method and circuit for controlling a display of a modulated image, which enable a modulated image such as a persistence image to be rapidly displayed.

It is another object of the present invention to provide an image display method and device which enable a modulated image to be displayed substantially in real time in response to an image data input.

It is a further object of the present invention to provide an image display method and device for implementing the modulated image display control as described above.

To achieve the above objects, the present invention provides a method of controlling a display of a modulated image on a raster scan type display in response to an input image frame comprised of a frame of input pixel data. The method includes the steps of receiving input pixel data within the input image frame, and adding modulated pixel data for displaying a modulated image to the received input pixel data to form display pixel data within a display image frame supplied to the display. According to the present invention, the modulated image may be a persistence added image, and the modulated pixel data may be persistence pixel data.

The present invention also provides a method of controlling persistence display in a raster scan type display in response to an input image frame comprised of a frame of input pixel data. The method includes the steps of receiving input pixel data within the input image frame supplied to the display, and adding persistence pixel data for persistence display to the received input pixel data to generate display pixel data within a display image frame supplied to the display.

According to the present invention, the step of adding persistence pixel data may include the steps of receiving the display pixel data within the display image frame, forming, from the display pixel data, persistence pixel data within a persistence image frame to be added to the input pixel data within the input image frame during a frame immediately after the input image frame containing the input pixel data, and adding to the input pixel data within the input image frame persistence pixel data within the persistence image frame at a pixel position corresponding to the input pixel data. Further, the step of forming persistence pixel data may include forming the persistence pixel data during a period of a frame occurring immediately after the input image frame containing the input pixel data. Alternatively, the step of forming persistence pixel data may include forming the persistence pixel data during the period of the same frame as the input image frame containing the input pixel data. In this event, the step of forming persistence pixel data may include the steps of attenuating the display pixel data within the display image frame in accordance with a predetermined scheme to generate persistence pixel data, storing the persistence pixel data in a persistence frame memory, and storing the display pixel data in the persistence frame memory as persistence pixel data to form the persistence image frame.

The present invention also provides an image display method which includes the method of controlling persistence display described above. In this method, the image may be a waveform.

The present invention further provides a modulated image display control circuit for controlling display of an image on a raster scan type display based on an input image frame comprised of a frame of input pixel data. The circuit includes modulated pixel data adding means for adding modulated pixel data to input pixel data within the input image frame to generate display pixel data within a display image frame supplied to the display. In this circuit, the modulated image may be a persistence added image, and the modulated pixel data may be persistence pixel data.

The present invention further provides a persistence display control circuit for controlling display of an image on a raster scan type display based on an input image frame comprised of a fame of input pixel data. The circuit includes persistence data adding means for adding persistence pixel data to input pixel data within the input image frame supplied to the display to generate display pixel data within a display image frame supplied to the display.

According to the present invention, the persistence data adding means may include persistence pixel data forming means connected to receive the display pixel data within the display image frame for forming, from the display pixel data, persistence pixel data within a persistence image frame to be added to the input pixel data within the input image frame during a frame occurring immediately after the input image frame containing the input pixel data, and persistence pixel data adding means connected to receive the persistence pixel data within the persistence image frame from the persistence pixel data forming means and to receive the input pixel data within the input image frame for adding to the input pixel data persistence pixel data within the persistence image frame at a pixel position corresponding to the input pixel data.

According to the present invention, the persistence pixel data forming means may be configured to form the persistence pixel data during a period of the frame immediately after the input image frame containing the input pixel data. In this configuration, the persistence pixel data forming means may include persistence frame memory means for storing the display pixel data within the display image frame, and persistence pixel data forming means connected to receive the display pixel data within the display image frame from the persistence frame memory means for attenuating the display pixel data in accordance with a predetermined scheme to form the persistence pixel data.

Also, according to the present invention, the persistence pixel data forming means may be configured to form the persistence pixel data during a period of the same frame as the input image frame containing the input pixel data. In this configuration, the persistence pixel data forming means may include persistence pixel data forming means for attenuating the display pixel data within the display image frame in accordance with a predetermined scheme to form the persistence pixel data, and persistence frame memory means for storing the persistence pixel data from the persistence pixel data forming means to form the persistence image frame.

Further, according to the present invention, the persistence frame memory means may include a first and a second frame memory, and selecting means for alternately selecting the first and second frame memories as a read frame memory and a write frame memory, respectively, on a frame-by-frame basis. In this event, the selecting means can connect the persistence pixel data adding means to the read frame memory, and connect the persistence pixel data forming means to the write frame memory. In addition, one of the first and second frame memories selected as the read frame memory stores the persistence image frame formed during a frame immediately before the input image frame. The other frame memory of the first and second frame memories selected as the write frame memory stores the persistence image frame for use during a frame occurring immediately after the input image frame. In the next frame, the frame memory selected as the read frame memory is selected as a write frame memory by the selecting means to store the persistence image frame for use during a frame next to the next frame, and the other frame memory selected as the write frame memory is selected as the read frame memory by the selecting means such that the persistence image frame stored in the write frame memory is able to serve as the persistence image frame for the next frame.

The present invention further provides an image display device which includes the persistence display control circuit.

### BRIEF DESCRIPTION OF THE INVENTION

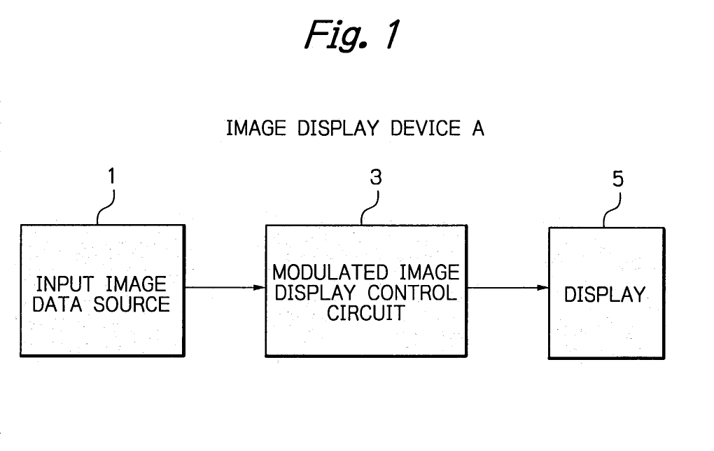

FIG. 1 is a block diagram illustrating an image display device A for displaying a modulated image according to a first embodiment of the present invention;

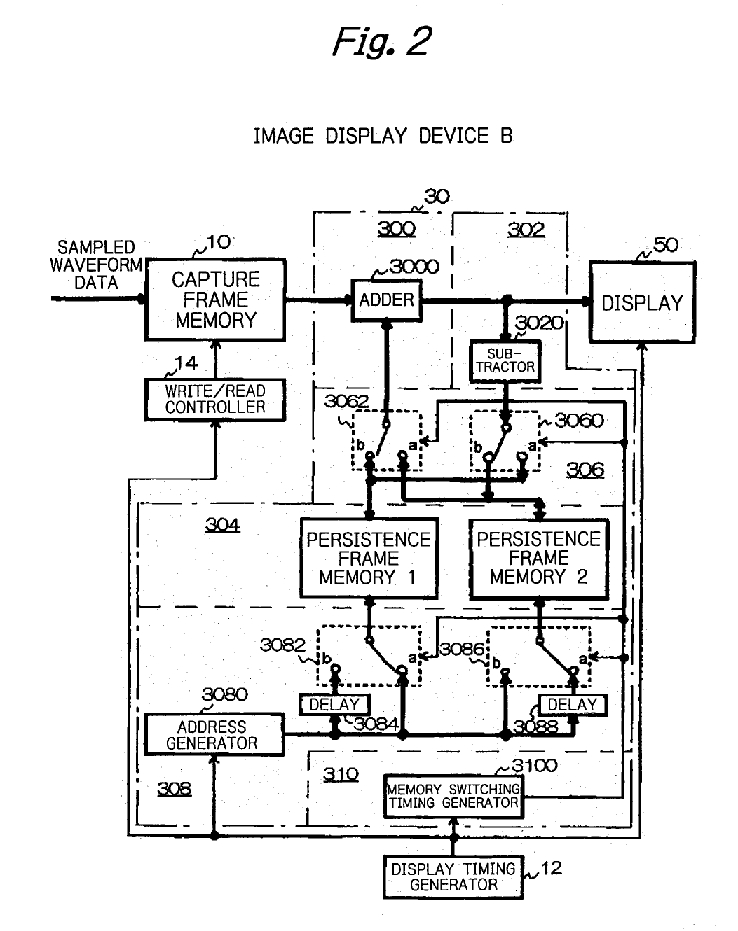

FIG. 2 is a block diagram of an image display device B in one embodiment which more specifically embodies the image display device A illustrated in FIG. 1;

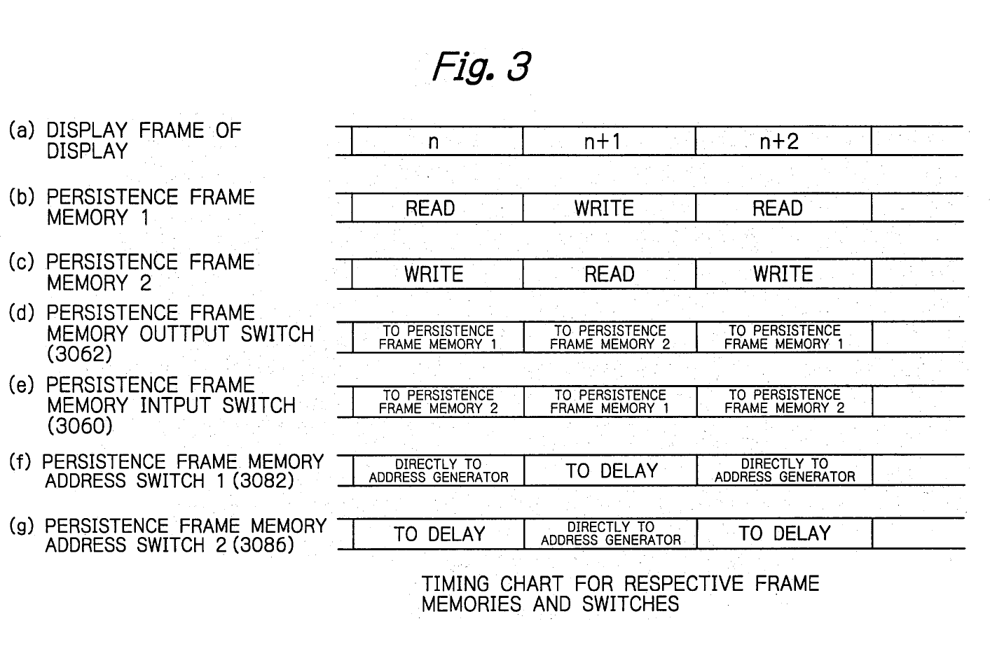

FIG. 3 is a timing diagram showing the operation of the image display device B; and

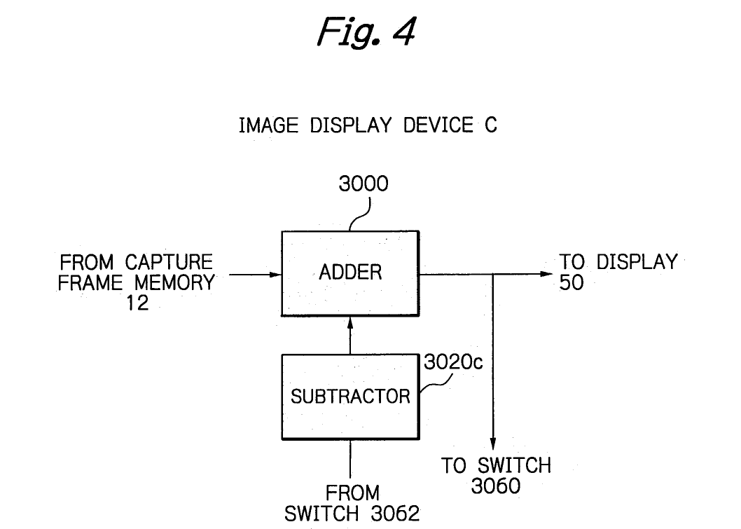

FIG. 4 is a block diagram illustrating an image display device C according to another embodiment of the present invention, showing only parts different from the image display device B in FIG. 2.

### DETAILED DESCRIPTION OF THE INVENTION

In the following description, the present invention will be described in detail with reference to a number of embodiments.

FIG. 1 illustrates an image display device A for displaying a modulated image according to a first embodiment of the present invention. As illustrated, the display device A comprises an input image data source 1; a modulated image display control circuit 3 connected to an output of the input image data source 1 for receiving image data; and a display 5 connected to an output of the control circuit 3 for receiving modulated image data. The display 5 may be, for example, a raster scan type CRT (cathode ray tube) display, or a liquid crystal display (LCD). The input image data source 1 samples waveform data, for example, in a conventional analog oscilloscope, and supplies digital image data converted to X-Y data for display in the raster scan type display. The image data is comprised of continuous image data frames for raster scan display, and each image frame is comprised of a plurality of pixel data words. The modulated image display control circuit 3 modulates each of input image frames, received as an input, to generate a modulated image frame. The modulation used includes addition of persistence. The modulation additionally includes other arbitrary modifications of images. More specifically, the display control circuit 3 comprises a modulated image adder circuit which forms a modulated pixel data word for addition from each of input pixel data words which make up an input image data frame depending on the content of modulation. The adder circuit further operates to add the modulated pixel data word formed thereby to each input pixel data word, and directly supplies the display 5 with a display pixel data word resulting from the addition without intervention of a memory such as a frame memory. In this way, the image display device A can provide a higher data transfer rate from the input image data source 1 to the display 5 than in the conventional art, thereby displaying an image substantially in real time.

Referring next to FIG. 2, description will be made of an image display device B in one embodiment which more specifically embodies the image display device A illustrated in FIG. 1. The image display device B adds a persistence image as image modulation. More specifically, the image display device B comprises a capture frame memory 10; a persistence data addition unit 30; and a display 50, as illustrated. The image display device B also comprises a display timing generator 12 and a read/write controller 14 for controlling a display timing. The capture frame memory 10 is similar to that of the prior art in that it has an input for receiving a sampled input waveform pixel data word, and writes the pixel data received at the input frame by frame to form an X-Y converted input image data frame. The capture frame memory 10 also has an output from which the formed image data frame is read on a pixel-by-pixel basis. The capture frame memory 10 further has a control input connected to an output of the write/read controller 14 for receiving signals for controlling a write from and a read into the memory 10, for example, an address and a clock. Here, the display timing generator 12 comprises a clock generator for generating a synchronization signal or a reference clock (for example, at a frequency of 65 MHz) which serves as a basis for forming the control signals. The display timing generator 12 generates a synchronization signal based on the display frame frequency (for example, at 60.003 Hz), horizontal frequency (for example, at 48.363 kHz) or the like of the display 50. The write/read controller 14, which has an input for receiving the synchronization signal, generates control signals including the address and clock at the output, as described above.

The persistence data addition unit 30 has an input connected to the output of the capture memory 10, and an output connected to an input of the display 50, and adds a persistence pixel data word to each of input pixel data words, which make up an input image frame received at the input, and then outputs the resulting display pixel data word, as will be later described. The display 50 has an input connected to the output of the persistence data addition unit 30, and a control input connected to receive the synchronization signal from the display timing generator 12. The display 50 may be a raster scan type CRT display or an LCD display, as is the case with the foregoing.

Describing the persistence data addition unit 30 in greater detail, the persistence data addition unit 30 generally comprises a persistence pixel data word addition unit 300; a persistence pixel data word formation unit 302; a persistence frame memory pair unit 304; a frame memory selector 306; an address generator unit 308; and a memory switching timing generator 310. More specifically, the persistence pixel data word addition unit 300 comprises, for example, an adder 3000 which has an input for receiving an input pixel data word from the capture frame memory 10; another input for receiving a persistence pixel data word from the selector 306; and an output for generating the display pixel data word resulting from the addition of the two inputs. The persistence pixel data word formation unit 302 comprises, for example, a subtractor 3020 which has an input connected to the output of the adder 3000 for receiving a display pixel data word from the adder 3000, and attenuates the received pixel data word in a predetermined attenuation sequence to form a persistence pixel data word. For example, the attenuation sequence may include subtracting the same amount from the received pixel data word each time, whereas the attenuation may be implemented by another scheme (for example, a scheme of using a lookup table for providing, for example, a non-linear attenuation characteristic). The persistence pixel data word thus formed is generated at the output of the subtractor 3020. The output of the subtractor 3020 is next connected to the persistence frame memory pair unit 304 through the frame memory selector 306. More specifically, the frame memory selector 306 comprises an input switch 3060 and an output switch 3062. The input switch 3060 has an input terminal connected to the output of the subtractor 3020, and two output terminals a, b. The output switch 3062 in turn has two input terminals a, b and one output terminal which is connected to the other input of the adder 3000. These two switches 3060, 3062 each have a control input such that they are switched to their respective terminals a or b depending on a signal at the control inputs.

The memory switching timing generator 310 comprises a memory switching timing generator 3100 which has an input connected to the output of the display timing generator 12 for receiving the synchronization signal, and generates a memory switching control signal at an output. The memory switching control signal inverts the state every frame period based on the synchronization signal. The switches 3060, 3062 switch between the terminals a and b, as described above, in response to the memory switching control signal.

The persistence frame memory pair unit 304 comprises two persistence frame memories 1, 2. Each of the frame memories 1, 2 has a capacity of one frame of persistence pixel data words, i.e., a persistence image data frame. The persistence frame memory 1 has a data input terminal connected to the output terminal a of the input switch 3060 for receiving an input, and a data output terminal connected to the input terminal b of the output switch 3062 for generating an output. The persistence frame memory 2 in turn has a data input terminal connected to the output terminal b of the input switch 3060 for receiving an input, and a data output terminal connected to the input terminal a of the output switch 3062 for generating an output. As a result, when the respective switches 3060, 3062 are in a first state, i.e., on the a side, the persistence frame memory 1 functions as a write frame memory while the persistence frame memory 2 functions as a read frame memory. On the other hand, when the respective switches 3060, 3062 are in a second state, i.e., on the b side, the persistence frame memory 1 functions as a read frame memory while the persistence frame memory 2 functions as a write frame memory. In this way, by using the two frame memories alternately for writing and reading every frame period, a read of a persistence image frame for use with a current frame can be performed simultaneously with a write of a persistence image frame for use with the next frame. Each of the frame memories 1, 2 has an address input for receiving an address for writing and reading.

The address generator unit 308 comprises an address generator 3080; and two sets of address switches 3082, 3086 and delays 3084, 3088. A first set of address switch 3082 and delay 3084 is associated with the persistence frame memory 1, while a second set of address switch 3086 and delay 3088 is associated with the persistence frame memory 2. More specifically, the address generator 3080 has an input connected to the output of the display timing generator 12 for receiving the synchronization signal, and generates address signals at an output for sequentially addressing memory locations in the associated frame memory. The address switch 3082 in the first set has two input terminals a, b and one output terminal. The input terminal a is directly connected to the output of the address generator 3080; the input terminal b is connected to the output of the address generator 3080 through the delay 3084; and the output terminal is connected to the address input of the persistence frame memory 1. The delay 3084 provides a delay equal to a delay caused by the adder 3000 and subtractor 3020, such that an address for reading from the frame memory is used as an address for writing into the frame memory by delaying the read address by the delay time. Thus, the input terminal a functions as a terminal for receiving an address for reading from the persistence frame memory 1, and the input terminal b functions as a terminal for receiving an address for writing into the persistence frame memory 1. The address switch 3082 has a control input which is connected to the output of the memory switching timing generator 310 for receiving the memory switching control signal. In this way, the address switch 3082 switches to the a side or to the b side depending on the state of the memory switching control signal. Similarly, the second set of address switch 3086 and delay 3088 has substantially the same configuration as the first set, except that the delay 3088 is connected to the input terminal a of the switch 3086. This is because the persistence frame memory 2 is operated reverse to the write/read operations of the persistence frame memory 1.

Next, operation of the image display device B having the foregoing configuration will be described with reference to FIG. 3. First, FIG. 3(a) shows three continuous display frames n, n+1, n+2 of the display which are also frames of the capture frame memory 10. The operation of the persistence data adder unit 30 in the image display device B may be divided into the following four steps: (1) reception of an input image; (2) formation of a persistence image frame; (3) addition of the persistence image frame; and (4) display. In the present invention, these four operation steps are performed simultaneously in each frame period, wherein respective operation steps other than (2) formation of a persistence image frame are performed for a certain single frame (for example, the frame n), while the formation of a persistence image frame is performed for the next frame (for example, the frame n+1). More specifically, in the reception of an input image, the adder 3000 receives an input pixel data word from the capture memory 10. Next, in the formation of a persistence image frame, the subtractor 3020 attenuates the input pixel data word to form a persistence pixel data word which is written into and stored in the persistence frame memory for use in the next frame. In the addition of the persistence image frame, the persistence pixel data word stored in the persistence frame memory in the preceding frame is read out and added to an input pixel data word by the adder 3000 to form a display pixel data word. In the next display operation, the display 50, which receives the display pixel data word, displays an image represented by the input display pixel data word in raster scan form.

Describing the operation in greater detail, during the frame n, for example, the switches 3060, 3062 are on the b side, while the switches 3082, 3086 are on the a side, causing the persistence frame memory 1 to perform a read operation (FIG. 3(b)), and the persistence frame memory 2 to perform a write operation (FIG. 3(c)). In this event, the adder 3000 adds the persistence data word read from the persistence frame memory 1 to an input pixel data word output from the capture frame memory 10 (FIGS. 3(d) and 3(f)), and supplies the display 50 with a display pixel data word resulting from the addition. In this way, the pixel data word read from the capture frame memory 10 is directly supplied to the display 50 (FIG. 3(a)) without any intervention of a frame memory, so that the data transfer rate can be increased to the reading rate of the capture frame memory 10. During the same frame period, the persistence frame memory 2 writes a persistence pixel data word (FIGS. 3(e) and 3(g)) for use in the next frame n+1 which is received from the subtractor 3020. Next, during the frame n+1, the switches 3060, 3062 are switched to the opposite a side, and the switches 3082, 3086 to the opposite b side, causing the persistence frame memory 1 to perform a write operation, and the persistence frame memory 2 to perform a read operation. As a result, in the frame n+1, the persistence frame memory 2 supplies the adder 3000 with the persistence pixel data word stored during the frame n. On the other hand, the persistence frame memory 1 functions as a write memory in this event, and therefore operates to store a persistence pixel data word for use in the next frame n+2. Subsequently, the foregoing operations are repeated.

As described above, two persistence frame memories are provided for use in alternate writing and reading of persistence pixel data words, and read/write cycles of the two persistence frame memories are shifted such that they alternately perform a read and a write, thereby enabling persistence pixel data words to be simultaneously written into one persistence frame memory and read from the other persistence frame memory. As a result, a frame period for forming a persistence image frame can be removed from a transmission path from the capture memory 10 to the display 50, thereby increasing data transfer rate from the capture frame memory 10 to the display 50, to display the image substantially in real time.

Next, an image display device C according to another embodiment will be described with reference to FIG. 4. Since the image display device C is substantially identical to the image display device B of FIG. 2, the following description will be centered only on different parts. Specifically, in the image display device C of FIG. 4, a persistence pixel data word formation unit, i.e., a subtractor 3020c is disposed on the input side of the adder 3000, instead of the output side, such that the output of the adder 3000 is sent to the persistence frame memory pair unit 304 directly through the frame memory selector 306 without via the subtractor. Thus, the persistence pixel data word is formed from a display pixel data word when it is read from the persistence frame memory and input to the adder 3000. The image display device C thus configured provides similar results to those of the image display device B. As will be apparent to those skilled in the art, the formation of timings and addresses for writing and reading into and from the memories may be modified in accordance with an associated delay.

In the embodiments of the present invention described above in detail, a persistence added image has been described as a modulated image, however, as should be understood by those skilled in the art, the present invention can be applied to any arbitrary additional image which must be formed on the basis of an input image. Also, for purposes of description, the predetermined attenuation sequence for forming a persistence pixel data word involves, as one example, decreasing a same amount from a pixel data word each time irrespective of a displayed content. The present invention, however, can employ any other arbitrary type of attenuation sequence or attenuation scheme for providing a variable persistence characteristic.

According to the present invention described above in detail, an improved data transfer rate between the image input and the display in the image display device enables the image display device to display a persistence image more rapidly than before, so that the image can be displayed substantially in real time. The use of the frame memory pair permits the formation of a persistence image to be performed simultaneously with the addition of the persistence image, facilitating a more rapid display of the persistence image. Also, by virtue of improved real time display of an image, when an image captured by a camera is monitored on a waveform monitor, the image can be displayed on the monitor with less delay, thereby reducing discomfort of an operator. Furthermore, not limited to a persistance added image, the present invention can rapidly display an image to which another modulated image is added.

What is claimed is:

1. A method of controlling a display of a modulated image on a raster scan type display in response to an input image frame comprised of a frame of input pixel data, said method comprising the steps of:
receiving input pixel data within said input image frame; and
adding modulated pixel data for displaying a modulated image to said received input pixel data to form display pixel data within a display image frame supplied to said display.

2. A method according to claim 1, wherein:
said modulated image is a persistence added image; and
said modulated pixel data is persistence pixel data.

3. A method of controlling persistence display on a raster scan type display in response to an input image frame comprised of a frame of input pixel data, said method comprising the steps of:
receiving input pixel data within said input image frame supplied to said display; and
adding persistence pixel data for persistence display to said received input pixel data to generate display pixel data within a display image frame supplied to said display.

4. A method according to claim 3, wherein said step of adding persistence pixel data includes the steps of:
receiving said display pixel data within said display image frame;
forming, from said display pixel data, persistence pixel data within a persistence image frame to be added to said input pixel data within said input image frame during a frame occurring immediately after said input image frame containing said input pixel data; and
adding to said input pixel data within said input image frame a persistence pixel data within said persistence image frame at a pixel position corresponding to said input pixel data.

5. A method according to claim 4, wherein:
said step of forming persistence pixel data includes forming said persistence pixel data during a period of a frame immediately after said input image frame containing said input pixel data.

6. A method according to claim 4, wherein:
said step of forming a persistence pixel data includes forming said persistence pixel data during the period of the same frame as said input image frame containing said input pixel data.

7. A method according to claim 6, wherein said step of forming a persistence pixel data includes the steps of:
attenuating said display pixel data within said display image frame in accordance with a predetermined scheme to generate persistence pixel data;
storing said persistence pixel data in a persistence frame memory; and
storing said display pixel data in said persistence frame memory as persistence pixel data to form said persistence image frame.

8. An image display method comprising the method of controlling persistence display according to any of claims 3 to 7.

9. An image display method according to claim 8, wherein:
said image is a waveform.

10. A modulated image display control circuit for controlling a display of an image on a raster scan type display based on an input image frame comprised of a frame of input pixel data, said circuit comprising:
modulated pixel data adding means for adding modulated pixel data to input pixel data within said input image frame to generate display pixel data within a display image frame supplied to said display.

11. A modulated image display control circuit according to claim 10, wherein:
said modulated image is a persistence added image; and
said modulated pixel data is persistence pixel data.

12. A persistence display control circuit for controlling a display of an image on a raster scan type display based on an input image frame comprised of a frame of input pixel data, said circuit comprising:
persistence data adding means for adding persistence pixel data to input pixel data within said input image frame supplied to said display to generate display pixel data within a display image frame supplied to said display.

13. A persistence display control circuit according to claim 12, wherein said persistence data adding means includes:
persistence pixel data forming means connected to receive said display pixel data within said display image frame for forming, from said display pixel data, persistence pixel data within a persistence image frame to be added to said input pixel data within said input image frame during a frame occurring immediately after said input image frame containing said input pixel data; and
persistence pixel data adding means connected to receive said persistence pixel data within said persistence image frame from said persistence pixel data forming means and to receive said input pixel data within said input image frame for adding to said input pixel data persistence pixel data within said persistence image frame at a pixel position corresponding to said input pixel data.

14. A persistence display control circuit according to claim 13, wherein:
said persistence pixel data forming means forms said persistence pixel data during a period of the frame immediately after said input image frame containing said input pixel data.

15. A persistence display control circuit according to claim 14, wherein said persistence pixel data forming means includes:
persistence frame memory means for storing said display pixel data within said display image frame; and
persistence pixel data forming means connected to receive said display pixel data within said display image frame from said persistence frame memory means for attenuating said display pixel data in accordance with a predetermined scheme to form said persistence pixel data.

16. A persistence display control circuit according to claim 13, wherein:
said persistence pixel data forming means forms said persistence pixel data during the period of the same frame as said input image frame containing said input pixel data.

17. A persistence display control circuit according to claim 16, wherein said persistence pixel data forming means includes:
persistence pixel data forming means for attenuating said display pixel data within said display image frame in accordance with a predetermined scheme to form said persistence pixel data; and
persistence frame memory means for storing said persistence pixel data from said persistence pixel data forming means to form said persistence image frame.

18. A persistence display control circuit according to claim 17, wherein said persistence frame memory means includes:
a first and a second frame memory; and
selecting means for alternately selecting said first and second frame memories as a read frame memory and a write frame memory, respectively, on a frame-by-frame basis.

19. A persistence display control circuit according to claim 18, wherein:
said selecting means connects said persistence pixel data adding means to said read frame memory while connecting said persistence pixel data forming means to said write frame memory.

20. A persistence display control circuit according to claim 19, wherein:
one of said first and second frame memories selected as said read frame memory stores said persistence image frame formed during a frame occurring immediately before said input image frame;
the other frame memory of said first and second frame memories selected as said write frame memory stores said persistence image frame for use during a frame occurring immediately after said input image frame;
said one frame memory selected as said read frame memory is selected as a write frame memory by said selecting means in the next frame to store said persistence image frame for use during a frame next to said next frame; and
said other frame memory selected as said write frame memory is selected as said read frame memory by said selecting means in the next frame such that said persistence image frame stored in said write frame memory serves as said persistence image frame for said next frame.

21. An image display device comprising the persistence display control circuit according to any of claims 12 to 20.

22. The image display device according to claim 21, further comprising:
an image data source for supplying said input image data.

23. The image display device according to claim 22, wherein said image is a waveform.
